(19) United States
(12) Patent Application Publication
(10) Pub. No.: US 2005/0153860 A1
(43) Pub. Date: Jul. 14, 2005

(54) Hydrophobic polyamine ethoxylates

(76) Inventors: Shankang Zhou, Beijing (CN); Randall Alan Watson, Beijing (CN); Jeffrey John Scheibel, Loveland, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/015,576

(22) Filed: Dec. 17, 2004

Related U.S. Application Data
(60) Provisional application No. 60/531,422, filed on Dec. 19, 2003.

(51) Int. Cl. C11D 7/42

(52) U.S. Cl. 510/392

(57) ABSTRACT

A hydrophobic polyamine ethoxylate and modifications thereof to give improved cleaning benefits, improved formulability, and prevention of formation of larger ordered aggregates with in the presence of hard water and anionic surfactant.

### CROSS REFERENCE TO RELATED APPLICATION

This application claims priority under 35 U.S.C. § 119(e) to U.S. provisional application No. 60/531422, filed Dec. 19, 2003.

### FIELD OF THE INVENTION

The present invention relates to a hydrophobic polyamine ethoxylates, a method of making hydrophobic polyamine ethoxylates, a cleaning composition comprising hydrophobic polyamine ethoxylates, and a method of using the same.

### BACKGROUND OF THE INVENTION

Outdoor soil removal (e.g., grass, mud, dirt) continues to be a challenge for the detergent manufacture, especially in stressed conditions having low temperature cleaning conditions (about 20° C.) with high free hardness (10 gpg hardness or more). For example, it is known to use different types of polymers to address removal of hydrophobic and hydrophilic soils such as mud, dirt, and grass from surfaces through the use of polycarboxylate and polyamine materials. One issue with these materials is that they require relatively high levels for efficacy. Such polymers also tend to be expensive for detergent formulations and use emerging or developing markets is presently limited.

Stressed conditions also give the additional problem of having anionic surfactants such as linear alkylbenzene sulfonates or alkyl sulfates form larger order aggregates. The aggregation of the anionic surfactant reduces the amount of the anionic surfactant available to clean.

Fatty diamine, triamine, and tetramines are known and ethoxylated fatty diamines such as ETHODUOMEEN T/25® having 15 average ethoxy moieties per nitrogen are known from suppliers such as Akzo Nobel Inc.. However, existing materials do not deliver the desired performance requirements for cleaning applications such as laundry or hard surface cleaning compositions.

There exists a need for materials that are relatively easy to manufacture from sustainable and readily available raw materials, which may be tuned to address specific formulability and performance requirements. A multifunctional material that provides cleaning of outdoor soils and gives surfactant boosting benefits (i.e., for preventing formation of larger ordered aggregates of anionic surfactant with free hardness during use) is desired.

Specific performance requirements include providing cleaning of hydrophobic stains (grease, oil) and hydrophilic stains (clay) associated with outdoor soils. Other specific performance requirements include increasing the amount of available surfactant in the system where free hardness forms higher order aggregates with the surfactant, especially anionic surfactant.

Formulability of such materials into granular and liquid laundry detergents, hard surface cleaners, liquid hand dishwashing compositions, as well as oil drilling compositions continues to challenge detergent formulators.

### SUMMARY OF THE INVENTION

The present invention relates to a hydrophobic polyamine ethoxylate characterized by having a general formula: 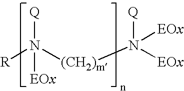
wherein R is a linear or branched C₁-C₂₂ alkyl, a linear or branched C₁-C₂₂ alkoxyl, linear or branched C₁-C₂₂ acyl, and mixtures thereof. The n index is from about 2 to about 9. Q is independently selected from an electron pair, hydrogen, methyl, ethyl, and mixtures thereof. The m index is from 2 to 6. The index x is selected to independently average from about 1 to about 70. EO represents an ethoxy moiety.

The present invention also relates to a process of making a hydrophobic polyamine ethoxylate as described from the corresponding non-alkoxylated polamine.

The present invention further relates to a cleaning composition comprising a hydrophobic polyamine ethoxylate as described. and a method of using a hydrophobic polyamine ethoxylate wherein the hydrophobic polyamine ethoxylate is formulated into a cleaning composition; and the cleaning composition is placed in contact with a at least a portion of a surface.

### DETAILED DESCRIPTION OF THE INVENTION

Hydrophobic polyamine ethoxylate materials are relatively easy to manufacture from sustainable and readily available raw materials, which may be tuned to address specific formulability and performance requirements.

The materials of the present invention provide cleaning benefits for hydrophobic stains (grease, oil) and hydrophilic stains (clay) associated with outdoor soils. These materials also demonstrate the ability for increasing the amount of available surfactant in system where free ion (for example, Ca²⁺ and Mg²⁺) hardness forms higher order aggregates with the surfactant, especially anionic surfactant.

Hydrophobic Polyamine Ethoxylate

Materials that are included in the invention of the present application include a hydrophobic polyamine ethoxylate characterized by comprising a general formula (I): 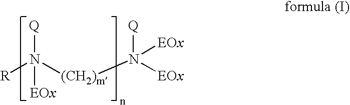
R of formula (I) is a linear or branched C₁-C₂₂ alkyl, a linear or branched C₁-C₂₂ alkoxyl, linear or branched C₁-C₂₂ acyl, and mixtures thereof; when R is branched, the branched may comprise from 1 to 4 carbon atoms; preferably R of formula (I) is a linear C₁₂ to C₁₈ alkyl. The alkyl, alkoxyl, and acyl may be saturated or unsaturated, preferably saturated. The n index of formula (I) is from about 2 to about 9, and such as from about 2 to about 5, further such as 3. Without being limited by a theory, it is believed that the hydrophobic tail R of formula (I) provides removal of hydrophobic stains such as oil. It is further believed that the hydrophobic tail R of formula (I) provides some prevention of the formation of larger ordered aggregates of an anionic surfactant in the presence of free hardness.

Q of formula (I) is independently selected from an electron pair, hydrogen, methyl, ethyl, and mixtures thereof. If the formulator desires a neutral backbone of the hydrophobic polyamine ethoxylate, Q of formula (I) should be selected to be an electron pair or a hydrogen. Should the formulator desire a quaternized backbone of the hydrophobic polyamine ethoxylate, at least on Q of formula (I) should be chosen from methyl, ethyl, preferably methylThe m index of formula (I) is from 2 to 6, preferably 3. The index x of formula (I) is independently selected to average from about 1 to about 70 ethoxy units, and such as an average from about 20 to about 70, further such as about 30 to about 50, for polyamines containing nonquaternized nitrogens; and such as from about 1 to about 10 for polyamines containing quaternized nitrogens.

The ethoxy units of the hydrophobic polyamine ethoxylate may be further modified by independently adding an anionic capping unit to any or all ethoxy units. Suitable anionic capping units include sulfate, sulfosuccinate, succinate, maleate, phosphate, phthalate, sulfocarboxylate, sulfodicarboxylate, propanesultone, 1,2-disulfopropanol, sulfopropylamine, sulphonate, monocarboxylate, methylene carboxylate, carbonates, mellitic, pyromellitic, citrate, acrylate, methacrylate, and mixtures thereof. Preferably the anionic capping unit is a sulfate, phosphate, and mixtures thereof.

In another embodiment of the present invention, the nitrogens of the hydrophobic polyamine ethoxylate are given a positive charge through quaternization. As used herein “quaternization” means quaternization or protonization of the nitrogen to give a positive charge to the nitrogens of the hydrophobic polyamine ethoxylate.

The tuning or modification may be combined depending upon the desired formulability and performance requirements. Specific, non-limiting examples of preferred hydrophobic polyamine ethoxylate of the present invention include formulae (II) and (III): 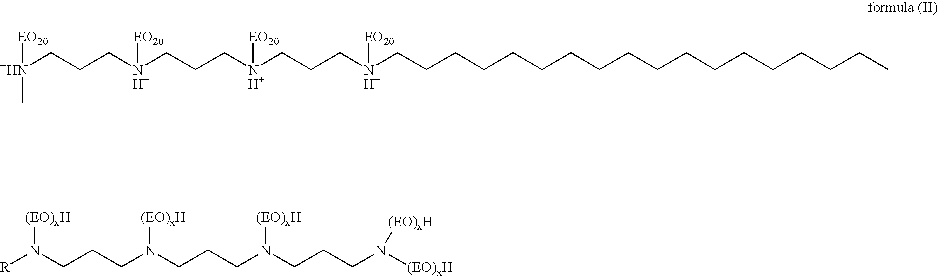
wherein R of formula (III) is a linear or branched C₁₂-C₁₆ alkyl, and mixtures thereof; x of formula (III) is from about 20 to about 70.
Process of Making

The present invention further relates to a process of making a hydrophobic polyamine ethoxylate of formula (I): 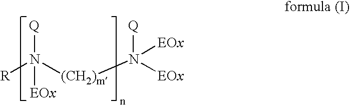
wherein R of formula (I) is a linear or branched C₁-C₂₂ alkyl, a linear or branched C₁-C₂₂ alkoxyl, linear or branched C₁-C₂₂ acyl, and mixtures thereof; when branched, R may be selected from a 1 to 4 carbon atom branch; preferably R of formula (I) is a linear C₁₂ to C₁₈ alkyl. The index n of formula (I) is from about 2 to about 9; and such as from about 2 to about 5, further such as 3; Q of formula (I) is independently selected from an electron pair, hydrogen, methyl, ethyl, and mixtures thereof; m of formula (I) is from 2 to 6; x of formula (I) independently averages from about 1 to about 70; such as from about 20 to about 70, further such as from about 30 to about 50, when a nonquaternized hydrophobic polyamine ethoxylate is desired; preferably from about 1 to about 10 for quaternized hydrophobic polyamine ethoxylate is desired; comprising the steps of:

(a) ethoxylating a hydrophobic polyamine having the general formula (IV): 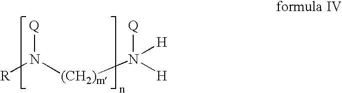
wherein R of formula (IV) is a linear or branched C₁-C₂₂ alkyl, a linear or branched C₁-C₂₂ alkoxyl, linear or branched C₁-C₂₂ acyl, and mixtures thereof; when branched, R may be selected from a 1 to 4 carbon atom branch; n of formula (IV) is from about 2 to about 9; Q of formula (IV) is independently selected from an electron pair or hydrogen; m of formula (IV) is from 2 to 6; such that each internal nitrogen independently averages from about 1 to about 70 ethoxy moieties, and the external nitrogen has two site that independently average from about 1 to 70 ethoxy moieties to form a hydrophobic polyamine ethoxylate, preferably from about 30 to about 70 for a process not comprising a quaternization step, discussed below, preferably from about 1 to about 10 for a process comprising a quaternization step, discussed below. As used herein “internal nitrogen” refers to the structure of formula (IV) above, wherein a nitrogen is shown to be inside the [ ]n brackets, signifying a repeating unit. As used herein “external nitrogen” refers to the structure of formula (IV) above, wherein a nitrogen is shown to be outside the [ ]n brackets, signifying a terminating unit.

The process may further comprise the optional step of (b) adding an anionic capping unit to form an anionic hydrophobic polyamine ethoxylate.

The process may further comprise the optional step of (c) quaternizing the nitrogens of the hydrophobic polyamine ethoxylate with a hydrogen, methyl, or ethyl, to form a cationic hydrophobic polyamine ethoxylate.

The process may further comprise the optional steps of (b) adding an anionic capping unit to form an anionic hydrophobic polyamine ethoxylate and further comprising the step of (c) quaternizing the nitrogens of the hydrophobic polyamine ethoxylate to form a zwitterionic hydrophobic polyamine ethoxylate.

### EXAMPLE 1

### Ethoxylation of Tallow Tetramine

Ethoxylation of the hydrophobic polyamine starting materials, such as tallow tetramine, may be completed by any known technique, such as that described in EP 174436 A1. Alternatively, the following ethoxylation steps may be taken.

Add tallow tetramine (37.99 g, 0.08677 mol) to an autoclave, purge the autoclave with nitrogen, heat tallow tetramine to 110-120° C.; stir the autoclave and apply vacuum to about 2.67 kPa (20 mmHg). Continuously apply a vacuum while cooling the autoclave to about 110-120° C. and introduce 3.75 g of a 25% sodium methoxide in methanol solution (0.01735 moles, to achieve a 5% catalyst loading based upon hydroxy moieties). Remove the methanol from the methoxide solution and remove the methoxide solution from the autoclave under vacuum. Use a device to monitor the power consumed by the agitator and also monitor the temperature and pressure. Agitator power and temperature values gradually increase as methanol is removed from the autoclave and the viscosity of the mixture increases and stabilizes in about 1.5 hours indicating that most of the methanol has been removed. Further heat and agitate the mixture under vacuum for an additional 30 minutes.

Remove the vacuum and cool to and keep the autoclave at 110° C. while charging the autoclave with nitrogen to 1725 kPa (250 psia) and then vent the autoclave to ambient pressure (101 kP; 1 atm). Charge the autoclave to 1380 kPa (200 psia) with nitrogen. Add ethylene oxide to the autoclave incrementally while closely monitoring the autoclave pressure, temperature, and ethylene oxide flow rate while maintaining the temperature between 110 and 120° C. and limiting any temperature increases due to reaction exotherm. After the addition of 462.5 g of ethylene oxide (10.50 mol, resulting in a total of 24.2 moles of ethylene oxide per mol of OH), the increase the temperature to 120° C. and stir the mixture for an additional 2 hours.

Collect the reaction mixture into a 22 L three neck round bottomed flask purged with nitrogen. Neutralize the strong alkali catalyst by slow addition of 1.67 g methanesulfonic acid (0.01735 moles) with heating (110° C.) and mechanical stirring. Purge the reaction mixture of residual ethylene oxide and deodorized by sparging an inert gas (argon or nitrogen) into the mixture through a gas dispersion frit while agitating and heating the mixture to 120° C. for 1 hour. The final reaction product, approximately 500g, is cooled slightly, and poured into a glass container purged with nitrogen for storage to achieve an EO₁₂₁ or an average of EO_{24.2} per NH.

### Alternative Ethoxylation of Tallow Tetramine EO35 (Average of EO7 per NH)

The example of is repeated as above with the exception that a total of 35 Ethylene oxides (EO) units per mole of tallow tetramine is added to the tallow tetramine to provide a tallow tetramine EO 35 or 7 EO repeat units per NH group.

### EXAMPLE 2

### Sulfation of Tallow Tetramine EO₁₂₁ (50:50 Mixture of EO₂₀ and EO₃₀)

Weigh into a 250 ml Erlenmeyer flask equipped with a magnetic stirring bar tallow tetramine EO_{24.2} (0.00489 mol) and methylene chloride (50 g). Cool the solution in an ice bath until the temperature reaches about 10° C. Add with stirring, chlorosulfonic acid (1.1 g, 0.0098 mol) from a pipette over about 1 minute. Stir the reaction solution for 2 hours, allowing a slow increase in temperature to room temperature (20° C.). Place a solution of sodium methoxide (6.0 g of 25% in methanol) in a 250 ml Erlenmeyer flask equipped with a magnetic stirring bar to form a base solution and cool the base solution in an ice bath to about 10° C. Slowly pour the reaction solution into the base solution with vigorous stirring. Measure the pH of the resulting solution to be about 11. Add to the resulting solution 100 ml distilled water. Strip the resulting emulsion on a rotary evaporator at 50° C. to afford about 29 g of active product. Integration of a proton NMR [500 MHz or 300 MHz; pulse sequence: s2pul, solvent D₂O; relax delay 1.000 sec; pulse 45.0 degrees, acq. time 2.345 sec] (new methylene with sulfate group peak at ˜4 ppm) indicates that 2 alcohol groups per molecule are sulfated.

### Alternative Sulfation of Tallow Tetramine EO₁₂₁ (50:50 Mixture of EO₂₀ and EO₃₀)

This reaction may be repeated using 2.2 g of chlorosulfonic acid (0.0189 mol) and then neutralized with 12 g of 25% sodium methoxide in methanol to afford about 30 g of product which proton NMR [500 MHz or 300 MHz; pulse sequence: s2pul, solvent D₂O; relax delay 1.000 sec; pulse 45.0 degrees, acq. time 2.345 sec] (new methylene with sulfate group peak at ˜4 ppm) indicates has 4 sulfates per molecule.

### EXAMPLE 3

### Quaternization of Tallow Tetramine EO₁₂₁ (50:50 mixture of EO₂₀ and EO₃₀)

Weigh into a 250 ml Erlenmeyer flask equipped with a magnetic stirring bar tallow tetramine EO_{24.2} (28.0 g, 0.00489 mol) and methylene chloride (50 g). Cool the solution in an ice bath to about 10° C. Add with stirring, dimethyl sulfate (0.62 g, 0.00489 mol) from a pipette. Stopper the flask and stir the solution overnight (about 14 hours). Strip the solution on the rotary evaporator at 50° C. to afford about 28 g of material. Integration of proton NMR [500 MHz or 300 MHz; pulse sequence: s2pul, solvent D₂O; relax delay 1.000 sec; pulse 45.0 degrees, acq. time 2.345 sec] indicates that one nitrogen per molecule is quaternized.

### Alternative Ouaternization of Tallow Tetramine EO₁₂₁ (50:50 Mixture of EO₂₀ and EO₃₀)

This reaction may be repeated using 1.24 g of dimethyl sulfate (0.00978 mol) and proton NMR [500 MHz or 300 MHz; pulse sequence: s2pul, solvent D₂O; relax delay 1.000 sec; pulse 45.0 degrees, acq. time 2.345 sec] indicates that 2 nitrogens are quaternized.

### Alternative Quaternization of Tallow Tetramine EO₁₂₁ (50:50 Mixture of EO₂₀ and EO₃₀)

This reaction may be repeated using 1.86 g of dimethyl sulfate (0.0147 mol) and proton NMR [500 MHz or 300 MHz; pulse sequence: s2pul, solvent D₂O; relax delay 1.000 sec; pulse 45.0 degrees, acq. time 2.345 sec] indicates that 3 nitrogens are quaternized.

Cleaning Compositions

The present invention further relates to a cleaning composition comprising the hydrophobic polyamine ethoxylate of the present invention. The cleaning compositions can be in any conventional form, namely, in the form of a liquid, powder, granules, agglomerate, paste, tablet, pouches, bar, gel, types delivered in dual-compartment containers, spray or foam detergents, premoistened wipes (i.e., the cleaning composition in combination with a nonwoven material such as that discussed in U.S. Pat. No. 6,121,165, Mackey, et al.), dry wipes (i.e., the cleaning composition in combination with a nonwoven materials, such as that discussed in U.S. Pat. No. 5,980,931, Fowler, et al.) activated with water by a consumer, and other homogeneous or multiphase consumer cleaning product forms.

In addition to cleaning compositions, the compounds of the present invention may be also suitable for use or incorporation into industrial cleaners (i.e. floor cleaners). Often these cleaning compositions will additionally comprise surfactants and other cleaning adjunct ingredients, discussed in more detail below. In one embodiment, the cleaning composition of the present invention is a liquid or solid laundry detergent composition.

In another embodiment, the cleaning composition of the present invention is a hard surface cleaning composition, preferably wherein the hard surface cleaning composition impregnates a nonwoven substrate. As used herein “impregnate” means that the hard surface cleaning composition is placed in contact with a nonwoven substrate such that at least a portion of the nonwoven substrate is penetrated by the hard surface cleaning composition, preferably the hard surface cleaning composition saturates the nonwoven substrate.

In another embodiment the cleaning composition is a liquid dish cleaning composition, such as liquid hand dishwashing compositions, solid automatic dishwashing cleaning compositions, liquid automatic dishwashing cleaning compositions, and tab/unit does forms of automatic dishwashing cleaning compositions.

The cleaning composition may also be utilized in car care compositions, for cleaning various surfaces such as hard wood, tile, ceramic, plastic, leather, metal, glass. This cleaning composition could be also designed to be used in a personal care composition such as shampoo composition, body wash, liquid or solid soap and other cleaning composition in which surfactant comes into contact with free hardness and in all compositions that require hardness tolerant surfactant system, such as oil drilling compositions.

Hydrophobic Polyamine Ethoxylate

The cleaning composition of the present invention may comprise from about 0.005% to about 30%, preferably from about 0.01 to about 10%, more preferably from about 0.1 to about 5% by weight of the cleaning composition of an hydrophobic polyamine ethoxylate as described herein.

Surfactants

The cleaning composition of the present invention may comprise a surfactant or surfactant system comprising surfactants selected from nonionic, anionic, cationic, ampholytic, zwitterionic, semi-polar nonionic surfactants; and other adjuncts such as alkyl alcohols, or mixtures thereof. The cleaning composition of the present invention further comprises from about from about 0.01% to about 90%, preferably from about 0.01% to about 80%, more preferably from about 0.05% to about 50%, most preferably from about 0.05% to about 40% by weight of the cleaning composition of a surfactant system having one or more surfactants.

Anionic Surfactants

Nonlimiting examples of anionic surfactants useful herein include:
a) C₈-C₁₈ alkyl benzene sulfonates (LAS);
b) C₁₀-C₂₀ primary, branched-chain and random alkyl sulfates (AS);
c) C₁₀-C₁₈ secondary (2,3) alkyl sulfates;
d) C₁₀-C₁₈ alkyl alkoxy sulfates (AEₓS) wherein preferably x is from 1-30;
e) C₁₀-C₁₈ alkyl alkoxy carboxylates preferably comprising 1-5 ethoxy units;
f) mid-chain branched alkyl sulfates as discussed in U.S. Pat. No. 6,020,303 and U.S. Pat. No. 6,060,443;
g) mid-chain branched alkyl alkoxy sulfates as discussed in U.S. Pat. No. 6,008,181 and U.S. at. No. 6,020,303;
h) modified alkylbenzene sulfonate (MLAS) as discussed in WO 99/05243, WO 99/05242, WO 99/05244, WO 99/05082, and WO 99/05084;
i) methyl ester sulfonate (MES); and
j) alpha-olefin sulfonate (AOS).
   Nonionic Surfactants

Non-limiting examples of nonionic surfactants include:
a) C₁₂-C₁₈ alkyl ethoxylates, such as, NEODOL® nonionic surfactants from Shell;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block alkyl polyamine ethoxylates such as PLURONIC® from BASF;
d) C₁₄-C₂₂ mid-chain branched alcohols, BA, as discussed in U.S. Pat. No. 6,150,322;
e) C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856;
f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779;
g) Polyhydroxy fatty acid amides as discussed in U.S. Pat. No. 5,332,528, WO 92/06162, WO 93/19146, WO 93/19038, and WO 94/09099; and
h) ether capped poly(oxyalkylated) alcohol surfactants as discussed in U.S. Pat. No. 6,482,994 and WO 01/42408.

Cationic Surfactants

Non-limiting examples of anionic surfactants include: the quaternary ammonium surfactants, which can have up to 26 carbon atoms.
a) alkoxylate quaternary ammonium (AQA) surfactants as discussed in U.S. Pat. Nos. 6,136,769;
b) dimethyl hydroxyethyl quaternary ammonium as discussed in 6,004,922;
c) polyamine cationic surfactants as discussed in WO 98/35002, WO 98/35003, WO 98/35004, WO 98/35005, and WO 98/35006;
d) cationic ester surfactants as discussed in US Patents Nos 4,228,042, 4,239,660 4,260,529 and U.S. Pat. No. 6,022,844; and
e) amino surfactants as discussed in U.S. Pat. No. 6,221,825 and WO 00/47708, specifically amido propyldimethyl amine.

Zwitterionic Surfactants

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Ampholytic Surfactants

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Semi-Polar Nonionic Surfactants

Non-limiting examples of semi-polar nonionic surfactants include: water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. See WO 01/32816, U.S. Pat. No. 4,681,704, and U.S. Pat. No. 4,133,779.

Gemini Surfactants

Gemini Surfactants are compounds having at least two hydrophobic groups and at least two hydrophilic groups per molecule have been introduced. These have become known as “gemini surfactants” in the literature, e.g., Chemtech, March 1993, pp 30-33, and J. American Chemical Soc., 115, 10083-10090 (1993) and the references cited therein.

Cleaning Adjunct Materials

In general, a cleaning adjunct is any material required to transform a cleaning composition containing only the minimum essential ingredients into a cleaning composition useful for laundry, hard surface, personal care, consumer, commercial and/or industrial cleaning purposes. In certain embodiments, cleaning adjuncts are easily recognizable to those of skill in the art as being absolutely characteristic of cleaning products, especially of cleaning products intended for direct use by a consumer in a domestic environment.

The precise nature of these additional components, and levels of incorporation thereof, will depend on the physical form of the cleaning composition and the nature of the cleaning operation for which it is to be used.

The cleaning adjunct ingredients if used with bleach should have good stability therewith. Certain embodiments of cleaning compositions herein should be boron-free and/or phosphate-free as required by legislation. Levels of cleaning adjuncts are from about 0.00001% to about 99.9%, by weight of the cleaning compositions. Use levels of the overall cleaning compositions can vary widely depending on the intended application, ranging for example from a few ppm in solution to so-called “direct application” of the neat cleaning composition to the surface to be cleaned.

Quite typically, cleaning compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials can be found in WO 99/05242.

Common cleaning adjuncts include builders, enzymes, polymers not discussed above, bleaches, bleach activators, catalytic materials and the like excluding any materials already defined hereinabove. Other cleaning adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents, surface and skin care agents. Suitable examples of such other cleaning adjuncts and levels of use are found in U.S. Pat. Nos. 5,576,282, 6,306,812 B1 and 6,326,348 B1.

Method of Use

The present invention includes a method for cleaning a surface or fabric. Such method includes the steps of contacting a hydrophobic polyamine ethoxylate of the present invention or an embodiment of the cleaning composition comprising the hydrophobic polyamine ethoxylate of the present invention, in neat form or diluted in a wash liquor, with at least a portion of a surface or fabric then optionally rinsing such surface or fabric. Preferably the surface or fabric is subjected to a washing step prior to the aforementioned optional rinsing step. For purposes of the present invention, washing includes but is not limited to, scrubbing, and mechanical agitation.

As will be appreciated by one skilled in the art, the cleaning compositions of the present invention are ideally suited for use in home care (hard surface cleaning compositions), personal care and/or laundry applications. Accordingly, the present invention includes a method for cleaning a surface and/or laundering a fabric. The method comprises the steps of contacting a surface and/or fabric to be cleaned/laundered with the hydrophobic polyamine ethoxylate or a cleaning composition comprising the hydrophobic polyamine ethoxylate. The surface may comprise most any hard surface being found in a typical home such as hard wood, tile, ceramic, plastic, leather, metal, glass, or may consist of a cleaning surfaces in a personal care product such as hair and skin. The surface may also include dishes, glasses, and other cooking surfaces. The fabric may comprise most any fabric capable of being laundered in normal consumer use conditions.

The cleaning composition solution pH is chosen to be the most complimentary to a surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

For use in laundry cleaning compositions, the compositions are preferably employed at concentrations from about 200 ppm to about 10000 ppm in solution (or wash liquor). The water temperatures preferably range from about 5° C. to about 60° C. The water to fabric ratio is preferably from about 1:1 to about 20:1.

The present invention included a method for cleaning a surface or fabric. Such method includes the step of contacting a nonwoven substrate impregnated with an embodiment of the cleaning composition of the present invention, and contacting the nonwoven substrate with at least a portion of a surface and/or fabric. The method may further comprise a washing step. For purposes of the present invention, washing includes but is not limited to, scrubbing, and mechanical agitation. The method may further comprise a rinsing step.

As used herein “nonwoven substrate” can comprise any conventionally fashioned nonwoven sheet or web having suitable basis weight, caliper (thickness), absorbency and strength characteristics. Nonwoven substrates can be generally defined as bonded fibrous or filamentous products having a web structure, in which the fibers or filaments are distributed randomly as in “air-laying” or certain “wet-laying” processes, or with a degree of orientation, as in certain “wet-laying” or “carding” processes. The fibers or filaments of such nonwoven substrates can be natural (e.g., wood pulp, wool, silk, jute, hemp, cotton, linen, sisal or ramie) or synthetic (e.g., rayon, cellulose ester, polyvinyl derivatives, polyolefins, polyamides or polyesters) and can be bonded together with a polymeric binder resin. Examples of suitable commercially available nonwoven substrates include those marketed under the tradename SONTARA® by DuPont and POLYWEB® by James River Corp.

As will be appreciated by one skilled in the art, the cleaning compositions of the present invention are ideally suited for use in hard surface applications. Accordingly, the present invention includes a method for cleaning hard surfaces. The method comprises the steps of contacting a hard surface to be cleaned with a hard surface solution or nonwoven substrate impregnated with an embodiment of the cleaning composition of the present invention. The method of use comprises the steps of contacting the cleaning composition with at least a portion of the nonwoven substrate, then contacting a hard surface by the hand of a user or by the use of an implement to which the nonwoven substrate attaches.

As will be appreciated by one skilled in the art, the cleaning compositions of the present invention are ideally suited for use in liquid dish cleaning compositions. The method for using a liquid dish composition of the present invention comprises the steps of contacting soiled dishes with an effective amount, typically from about 0.5 ml. to about 20 ml. (per 25 dishes being treated), preferably from about 3 ml. to about 10 ml., of the liquid dish cleaning composition of the present invention diluted in water. The actual amount of liquid dish cleaning composition used will be based on the judgment of user, and will typically depend upon factors such as the particular product formulation of the composition, including the concentration of active ingredients in the composition, the number of soiled dishes to be cleaned, the degree of soiling on the dishes, and the like. The particular product formulation, in turn, will depend upon a number of factors, such as the intended market (i.e., U.S., Europe, Japan, etc.) for the composition product. Suitable examples may be seen below in Table 3.

Generally, from about 0.01 ml. to about 150 ml., preferably from about 3 ml. to about 40 ml. of a liquid dish cleaning composition of the invention is combined with from about 2000 ml. to about 20000 ml., more typically from about 5000 ml. to about 15000 ml. of water in a sink having a volumetric capacity in the range of from about 1000 ml. to about 20000 ml., more typically from about 5000 ml. to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of use will comprise immersing the soiled dishes into a water bath without any liquid dish cleaning composition. A device for absorbing liquid dish cleaning composition, such as a sponge, is placed directly into a separate quantity of undiluted liquid dish cleaning composition for a period of time typically ranging from about 1 to about 5 seconds. The absorbing device, and consequently the undiluted liquid dish cleaning composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

As will be appreciated by one skilled in the art, the cleaning compositions of the present invention are also suited for use in personal cleaning care applications. Accordingly, the present invention includes a method for cleaning skin or hair. The method comprises the steps of contacting a skin / hair to be cleaned with a cleaning solution or nonwoven substrate impregnated with an embodiment of the cleaning composition of the present invention. The method of use of the nonwoven substrate when contacting skin and hair may be by the hand of a user or by the use of an implement to which the nonwoven substrate attaches.

Formulations

### Laundry Cleaning Compositions

TABLE 1

| | B | D | G | H |
|---|---|---|---|---|
| | Wt % | wt % | wt % | wt % |
| C₁₀₋₁₂ linear alkyl | 13.4-15.0 | 15.2-17.2 | 12.7 | 12.7 |
| sulphonate | | | | |
| C₁₂₋₁₄ alkyl | 2.8 | 2.8 | 3.0 | 3.0 |
| ethoxylate (EO = 9) | | | | |
| Builder¹ | 18 | — | — | — |
| Sequestrant² | — | 17 | — | — |
| enzyme | 0.35 | 0.40 | — | — |
| Polymer³ | 1-2 | 1-2 | 1 | 1 |
| Carboxy Methyl | 0.2 | 0.2 | 0.5 | — |
| Cellulose | | | | |
| suds suppressor⁴ | 0.01 | 0.01 | — | — |
| Polyacrylate⁵ | 0.80 | 0.8 | — | 0.5 |
| buffer | 4.0 | 2.0 | 6.0 | 6.0 |
| Carbonate | 11.0 | 15.0 | 8.0 | 8.0 |
| brightener | 0.08 | 0.08 | 0.03 | 0.03 |
| Sodium Sulfate | 34.83 | 32.33 | 65.09 | 65.09 |
| Water and minors | Ad 100 | Ad 100 | Ad 100 | Ad 100 |

¹sodium tripolyphosphate
²Zeolite A: Hydrated Sodium Aluminosilicate of formula Na₁₂(A10₂SiO₂)₁₂.27H₂O having a primary particle size in the range from 0.1 to 10 micrometers
³An hydrophobic polyamine ethoxylate according to Examples 1-3 and formulae (II) and (III) of the present application
⁴such as that available from Dow Corning
⁵Mw = 4500

### Hard Surface Cleaning Compositions

TABLE 2

| | floor | floor |
|---|---|---|
| | cleaning | cleaning |
| | wipe solution | solution |
| | J | L |
| | wt % | wt % |
| C₁₁ alcohol ethoxylate (EO = 5) | 0.03 | 0.03 |
| Sodium C₈ Sulfonate | 0.01 | 0.01 |
| Propylene Glycol n-Butyl | 2 | 2 |
| Ether | | |
| 2-Phenoxyethanol | 0.05 | 0.05 |
| Ethanol | | 3 |
| Polymer¹ | 0.015 | 0.015 |
| 2-Dimethylamino-2-methyl-2- | 0.01 | 0.01 |
| propanol (DMAMP) | | |
| perfume | 0.01-0.06 | 0.01-0.06 |
| Suds suppressor² | 0.003 | 0.003 |
| 2-methyl-4-isothaizolin-3one + | 0.015 | — |
| chloro derivativel | | |
| Water and minors | Ad 100 | Ad 100 |

¹polymer according to Examples 1-3 and formulae (II) and (III) of the present application.
²such as Dow Corning AF Emulsion or polydimethyl siloxane

### Liquid Dish Cleaning Compositions

TABLE 3

| | N | P | Q | R |
|---|---|---|---|---|
| | wt % | wt % | wt % | wt % |
| C₁₂₋₁₃ alcohol ethoxylate sulfate EO = 0.6 | 26 | 23 | 24 | 26 |
| Amine Oxide | 5.8 | 5.8 | 5.8 | 5.8 |
| C₈₋₁₂ alcohol ethoxylate EO = 8 | 2 | 2 | 2 | 2 |
| Ethanol | 2 | 2 | 2 | 2 |
| Sodium cumene sulfonate | 1.80 | 1.80 | 1.80 | 1.80 |
| NaCl | 1.4 | 1.4 | 1.4 | 1.4 |
| MgCl₂ | 0.2 | 0.2 | 0.2 | 0.2 |
| Suds Booster² | 0.2 | 0.2 | 0.2 | 0.2 |
| Polymer³ | 0.8 | 0.8 | 0.8 | 0.8 |
| Water & other trace components | To | To | To | To |
| (i.e., dye, perfume, diamine, etc.) | 100% | 100% | 100% | 100% |

¹as described in U.S. Pat. No. 6,645,925 B1
²such as P2000E (PPG-26) available from Dow Chemicals or PLURACOL ® P 2000 available from BASF.
³polymer according to Examples 1-3 and formulae (II) and (III) of the present application.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An hydrophobic polyamine ethoxylate characterized by having a general formula: 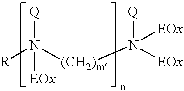
wherein R is a linear or branched C₁- C₂₂ alkyl, a linear or branched C₁-C₂₂ alkoxyl, linear or branched C₁-C₂₂ acyl, and mixtures thereof; n is from about 2 to about 9; Q is independently selected from an electron pair, hydrogen, methyl, ethyl, and mixtures thereof; m is from 2 to 6; x independently averages from about 1 to about 70.

2. The hydrophobic polyamine ethoxylate of claim 1 wherein the hydrophobic polyamine ethoxylate further comprises an anionic capping unit.

3. The hydrophobic polyamine ethoxylate of claim 1 wherein R is C₁₂ to C₁₈.

4. The hydrophobic polyamine ethoxylate of claim 1 wherein Q is an electron pair, hydrogen or a combination thereof; x independently averages from about 20 to about 70.

5. The hydrophobic polyamine ethoxylate of claim 1 wherein the hydrophobic polyamine ethoxylate further comprises at least one quaternized nitrogen.

6. The hydrophobic polyamine ethoxylate of claim 1 wherein Q is methyl, ethyl, or a combination thereof; x independently averages from about 2 to about 10.

7. A process of making a hydrophobic polyamine ethoxylate characterized by having a general formula: 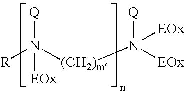
wherein R is a linear or branched C₁-C₂₂ alkyl, a linear or branched C₁-C₂₂ alkoxyl, linear or branched C₁-C₂₂ acyl, and mixtures thereof; n is from about 2 to about 9; Q is independently selected from an electron pair, hydrogen, methyl, ethyl, and mixtures thereof; m is from 2 to 6; x independently averages from about 1 to about 70; comprising the steps of:
(a) ethoxylating a hydrophobic polyamine having the general formula: 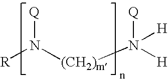
wherein R is a linear or branched C₁-C₂₂ alkyl, a linear or branched C₁-C₂₂ alkoxyl, linear or branched C₁-C₂₂ acyl, and mixtures thereof; n is from about 2 to about 9; Q is independently selected from an electron pair or hydrogen; m is from 2 to 6; such that each internal nitrogen independently averages from about 1 to about 70 ethoxy moieties, and the external nitrogen has two site that independently average from about 1 to 70 ethoxy moieties to form a hydrophobic polyamine ethoxylate

8. The process of claim 7 further comprises the step of (b) adding an anionic capping unit to form an anionic hydrophobic polyamine ethoxylate.

9. The process of claim 7 or 8 further comprise the step of (c) quaternizing the nitrogens of the hydrophobic polyamine ethoxylate with a hydrogen, methyl, or ethyl, to form a cationic hydrophobic polyamine ethoxylate.

10. A cleaning composition comprising a hydrophobic polyamine ethoxylate characterized by having a general formula: 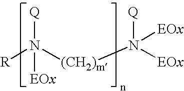
wherein R is a linear or branched C₁-C₂₂ alkyl, a linear or branched C₁-C₂₂ alkoxyl, linear or branched C₁-C₂₂ acyl, and mixtures thereof; n is from about 2 to about 9; Q is independently selected from an electron pair, hydrogen, methyl, ethyl, and mixtures thereof; m is from 2 to 6; x independently averages from about 1 to about 70.

11. The cleaning composition according to claim 10 wherein the cleaning composition further comprises a surfactant selected from anionic, nonionic, cationic, zwitterionic, ampholytic, and mixtures thereof.

12. The cleaning composition according to claim 11 wherein the cleaning composition is a laundry detergent composition.

13. The cleaning composition according to claim 12 wherein the laundry detergent composition is a liquid laundry detergent composition.

14. The cleaning composition according to claim 12 wherein the laundry detergent composition is a solid laundry detergent composition.

15. The cleaning composition according to claim 10 wherein the cleaning composition is a hard surface detergent composition.

16. The cleaning composition according to claim 10 wherein the cleaning composition is a personal cleansing composition.

17. The cleaning composition according to claim 10 wherein the cleaning composition is a liquid dish cleaning composition.

18. A method of using a hydrophobic polyamine ethoxylate characterized by having a general formula: 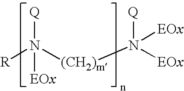
wherein R is a linear or branched C₁- C₂₂ alkyl, a linear or branched C₁-C₂₂ alkoxyl, linear or branched C₁-C₂₂ acyl, and mixtures thereof; n is from about 2 to about 9; Q is independently selected from an electron pair, hydrogen, methyl, ethyl, and mixtures thereof; m is from 2 to 6; x independently averages from about 1 to about 70; wherein the hydrophobic polyamine ethoxylate is formulated into a cleaning composition; and the cleaning composition is placed in contact with a at least a portion of a surface.

19. The method of claim 19 wherein the cleaning composition is a hard surface detergent composition and the surface is a hard surface such that the method further comprises contacting a impregnated nonwoven substrate with the hard surface detergent composition before contacting the hard surface.

20. The method of claim 19 wherein the cleaning composition is a liquid dish cleaning composition and the surface is a dish such that the method further comprises contacting the dish with an effective amount of the liquid dish cleaning composition, concurrently scrubbing the dish, and rinsing the dish.
